(19) United States
(12) Patent Application Publication
(10) Pub. No.: US 2003/0073445 A1
(43) Pub. Date: Apr. 17, 2003

(54) Apparatus for locating a receiver of radio communication

(75) Inventor: Stephen Chen, Chang-Hua (TW)

Correspondence Address: DOUGHERTY & TROXELL, SUITE 1404, 5205 LEESBURG PIKE, FALLS CHURCH, VA, 22041, US

(73) Assignee: E-Lead Electronic Co., Ltd.

(21) Appl. No.: 09/977,943

(22) Filed: Oct. 17, 2001

(51) Int. Cl. H04Q 7/20

(52) U.S. Cl. 455/456; 455/557

(57) ABSTRACT

An apparatus for locating a receiver of radio communication is introduced particularly to indicate the location of the receiver by a simple symbol so as to navigate a sender thereof to the location of the receiver without using a map. The apparatus, as a simple and practical position-locating device, mainly includes a system control unit, a direction detection unit, a longitude-and-latitude detection unit, an operation unit, a display unit, a data transmission unit, a radio communication interface unit, a voice transmission unit, a voice procession unit, a human-machine interface, a microphone and a speaker.

### BACKGROUND OF THE INVENTION

(1) Field of the Invention

The invention relates to an apparatus for locating a receiver of radio communication, and more particularly to an apparatus which can help a sender of the radio communication to locate simply and quickly the receiver without any information provided by a map bank.

(2) Description of the Prior Art

Currently, vehicle's global positioning system (GPS) can utilize satellites to help the driver not to get lost or circle-around while driving at an unfamiliar district. Yet, such a GPS needs a digital map bank to provide the road information all the time. In the case that two parties are dated to meet at a particular place, it is quite often for those using the GPS that a meeting point is missed due to non-identical explanation of the place. Consequently, even the GPS might have showed both parties that exact place had been met, yet it has a great possibility that they cannot still locate each other. Definitely, such an embarrassing situation results in wasting precious time. To overcome this practical problem, while dating with the GPS, a specific construction or landmark is always used to help the drivers locate the position. However, such a construction or landmark acceptable to both parties is seldom and therefore missing the meeting place still occurs due to drivers' unfamiliarity upon the district. It is easy to see that the cost GPS is almost useless under the situation described above.

### SUMMARY OF THE INVENTION

Accordingly, it is a primary object of the present invention to provide an apparatus for locating a receiver of radio communication which can resolve the described problem of the GPS and by which people can locate easily each other by the radio communication and an indicator provided by the apparatus of the present invention.

It is another object of the present invention to provide an apparatus for locating a receiver of radio communication which can help people meet exactly without missing unconsciously the dating place.

All these objects are achieved by the apparatus for locating a receiver of radio communication described below.

### BRIEF DESCRIPTION OF THE DRAWINGS

The present invention will now be specified with reference to its preferred embodiment illustrated in the drawings, in which

FIG. 1 is a block diagram to show a preferred embodiment of the apparatus for locating a receiver of radio communication in accordance with the present invention;

FIG. 2 is a flowchart of the apparatus of FIG. 1 at the end of the first party of the radio communication;

FIG. 3 is a flowchart of the apparatus of FIG. 1 at the end of the second party of the radio communication;

FIG. 4 is a schematic view of a preferred display unit in accordance with the present invention; and

FIG. 5 is a block diagram to show another preferred embodiment of the apparatus for locating a receiver of radio communication in accordance with the present invention.

### DESCRIPTION OF THE PREFERRED EMBODIMENT

The invention disclosed herein is directed to an apparatus for locating a receiver of radio communication. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

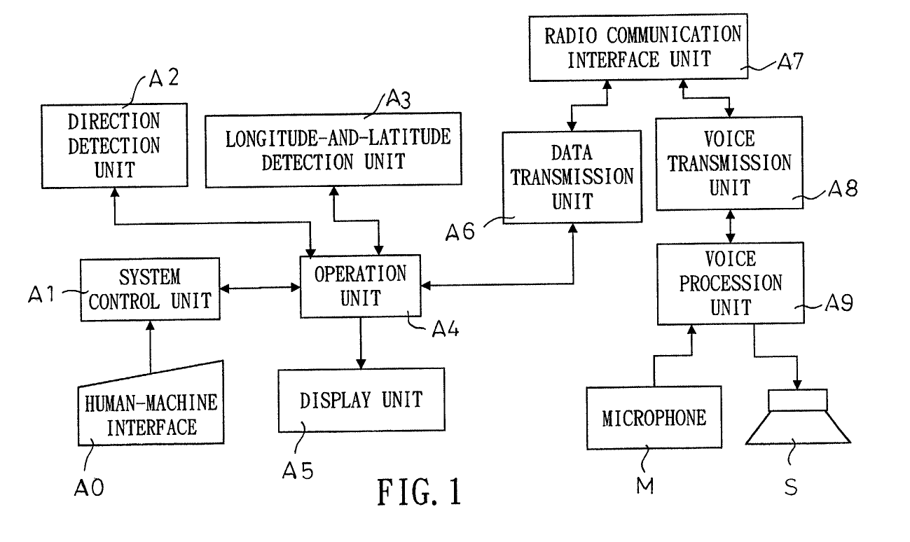

Referring now to FIG. 1, a block diagram of a preferred embodiment of the apparatus for locating a receiver of radio communication in accordance with the present invention is shown. The apparatus of the present invention includes a system control unit A1, a direction detection unit A2, a longitude-and-latitude detection unit A3, an operation unit A4, a display unit A5, a data transmission unit A6, a radio communication interface unit A7, a voice transmission unit A8, a voice procession unit A9, a human-machine interface A0, a microphone M and a speaker S.

In the present invention, the system control unit A1 is used to control all units of the apparatus.

In the present invention, the direction detection unit A2 can use a heading direction of a vehicle or the apparatus as a standard direction for judging a direction of the receiver. The direction detection unit A2 can be a gyroscope, an electronic compass, or any direction detection element that utilizes GPS Doppler effect.

In the present invention, the longitude-and-latitude detection unit A3 can utilize a GPS to receive a satellite's signals so as to obtain longitude and latitude data of the user for further computation in the operation unit A4.

In the present invention, the operation unit A4 is controlled by the system control unit A1 to receive signals from the direction detection unit A2, the longitude-and-latitude detection unit A3 and the data transmission unit A6. Those signals can include information of directions, latitudes, longitudes and other position data for both the user and the opposite user.

In the present invention, the display unit A5 is used to display the display data transmitted from the operation unit A4. The display unit A5 can be an LCD screen or any displayer that can illustrate the display data for navigating the user to meet the opposite user.

In the present invention, the data transmission unit A6 can enable the operation unit A4 to transform the longitude and latitude data of the user and the communication data of an opposite user. Also, the data transmission unit A6 can forward data to the radio communication interface unit A7 of the opposite user through the radio communication interface unit A7 of the user. The data transmission unit A6 can be a short message provided by the provider of the mobile phone system or by a digital data procession apparatus.

In the present invention, the radio communication interface unit A7 is used to establish radio connection with a radio communication device. The radio communication device can be a GSM system, a DCS system, a radio intercom, or any device for radio communication.

In the present invention, the voice transmission unit A8 can transform and forward voice signals of the voice procession unit A9 to the opposite user through the radio communication interface unit A7, or can transform incoming voice signals provided by the radio communication interface unit A7 into signals acceptable to the voice procession unit A9.

In the present invention, the voice procession unit A9 is used to process the voice signals from the microphone M and the voice transmission unit A8. The voice procession unit A9 is also able to eliminate noises, echoes and any unexpected voices.

In the present invention, the human-machine interface A0 is used for the user to input settings of the apparatus. The human-machine interface A0 can be a key-type or touch screen-type input device.

In the present invention, the microphone M can be used for the user to input voices.

In the present invention, the speaker S can be used for outputting the voice signals of the voice procession unit A9.

By providing all the units described above, the user is able to locate quickly and easily the position of the opposite user. The detail procedures are described as follows.

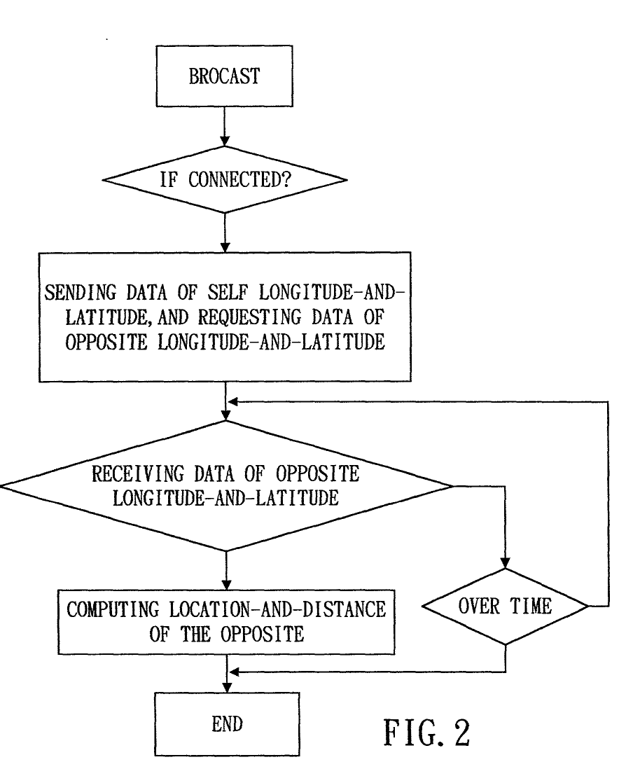

At the User End (Referred to FIG. 2):

1. Activate the human-machine interface A0 to start the system control unit A1 as well as all other units of the apparatus.

2. The radio transmission interface unit A7 issues a connection request signal to the radio transmission interface unit A7 of the opposite user for requesting a connection in between.

3. As the connection is established between the radio transmission interface units A7, the direction detection unit A2 and the longitude-and-latitude detection unit A3 can obtain the position signals from the satellite and can forward the signals to the operation unit A4 for being further transformed to become acceptable signals to the apparatus of the present invention. The acceptable signals are further transformed to respective radio signals by the data transmission unit A6 and then forwarded to the radio transmission interface unit A7 of the opposite user through the data transmission unit A6 for requesting the longitude and latitude data of the opposite user.

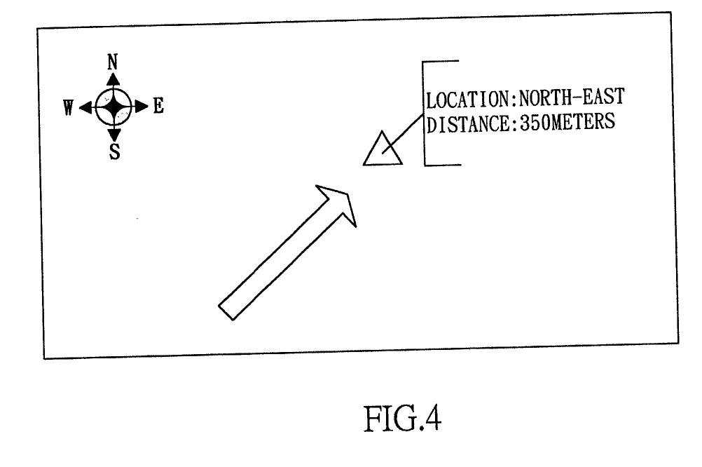

4. The operation unit A4 computes the direction and the longitude-and-latitude data received at the radio transmission interface unit A7. If the received data is not complete and the connection request is over time, proceeds to step 5. Otherwise, keep receiving data. After the incoming data is received completed, the operation unit A4 can calculate the location and direction of the opposite user and show them on the display unit A5 as shown in FIG. 4.

5. End of the process.

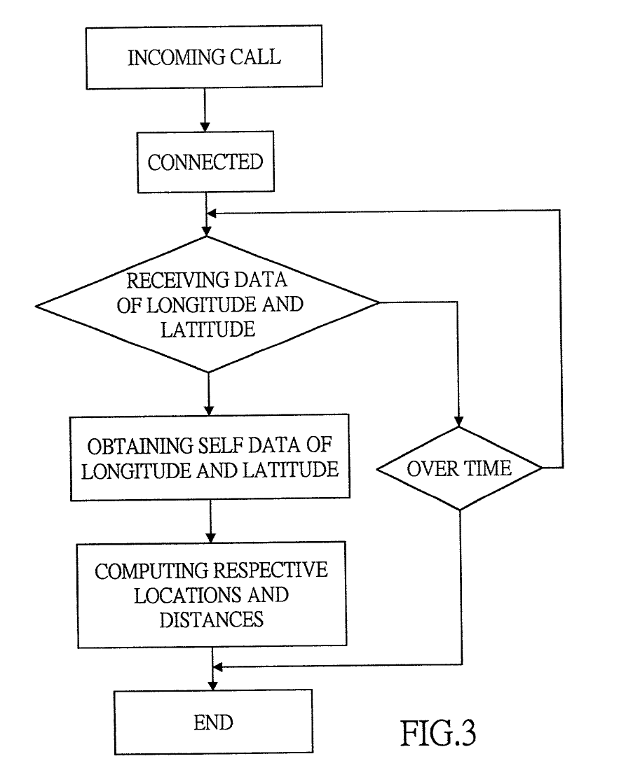

At the Opposite User End (Referred to FIG. 3):

1. The opposite user can utilize the human-machine interface A6 to start the system control unit A1 as well as all other units thereof.

2. The radio transmission interface unit A7 receives the connection request signal from the user and then activates to establish the radio connection in between.

3. The radio transmission interface units A7 receives the direction and the longitude-and-latitude data from the user, and then the operation unit A4 is used to process these data. If the received data is not complete and the job is over time, re-connection is required and the process jumps to step 6.

4. The direction detection unit A2 and the longitude-and-latitude detection unit A3 can obtain the position signals from the satellite and can forward the signals to the operation unit A4 for being further transformed to become acceptable signals to the apparatus of the present invention. The acceptable signals are further transformed to respective radio signals by the data transmission unit A6 and then forwarded to the radio transmission interface unit A7 of the user through the data transmission unit A6.

5. After the incoming data is received completed, the operation unit A4 can calculate the location and direction of the opposite user and show them on the display unit A5 as shown in FIG. 4.

6. End of the process.

As the process flow described above is fulfilled, exact respective locations of the user and the opposite user can be determined. Also, such useful data can be illustrated by an indicator on the display unit A5 at either end as shown in FIG. 4. The illustration on the display unit A5 can vary with the position changes of the user and the opposite user. In addition, both the user and the opposite user can utilize respective microphone M and speaker S to process radio communication through respective voice procession unit A9, respective voice transmission unit A8 and respective radio communication interface unit A7.

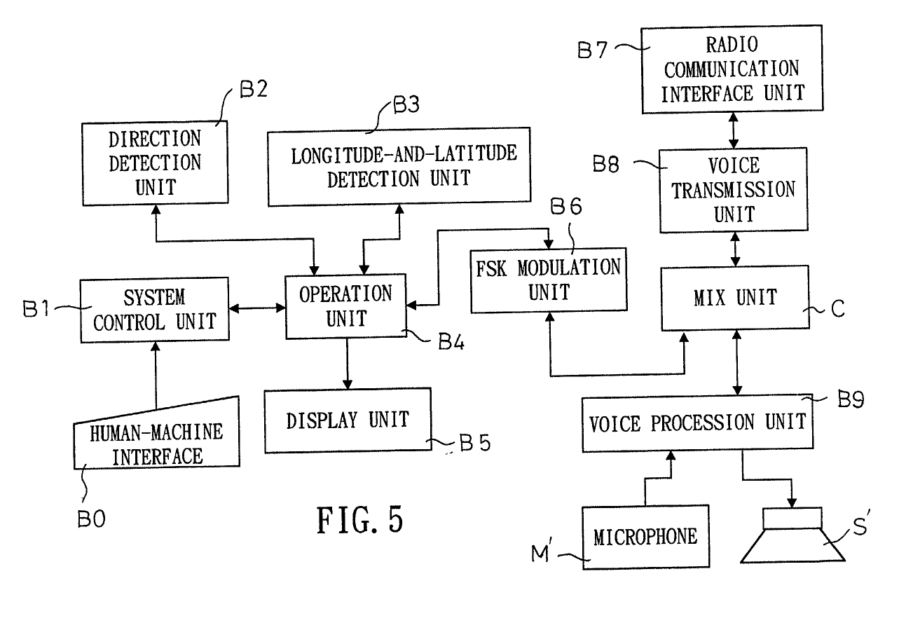

Referring now to FIG. 5, another embodiment of the apparatus for locating a receiver of radio communication in accordance with the present invention is present. In this embodiment, previous data transmission unit can include an FSK modulation unit and a mix unit for transforming digital data into voice-frequency signals to facilitate transmission of the radio transmission interface unit. The embodiment of the present invention includes a system control unit B1, a direction detection unit B2, a longitude-and-latitude detection unit B3, an operation unit B4, a display unit B5, an FSK modulation unit B6, a radio communication interface unit B7, a voice transmission unit B8, a voice procession unit B9, a human-machine interface B0, a mix unit C, a microphone M′ and a speaker S′.

The system control unit B1 is used to control all units of the apparatus.

The direction detection unit B2 can use a heading direction of a vehicle or the apparatus as a standard direction for judging a direction of the receiver. The direction detection unit B2 can be a gyroscope, an electronic compass, or any direction detection element that utilizes GPS Doppler effect.

The longitude-and-latitude detection unit B3 can utilize a GPS to receive a satellite's signals so as to obtain longitude and latitude data of the user for further computation in the operation unit B4.

The operation unit B4 is controlled by the system control unit B1 to receive signals from the direction detection unit B2, the longitude-and-latitude detection unit B3 and the data transmission unit B6. Those signals can include information of directions, latitudes, longitudes and other position data for both the user and the opposite user.

The display unit B5 is used to display the display data transmitted from the operation unit B4. The display unit B5 can be an LCD screen or any displayer that can illustrate the display data for navigating the user to meet the opposite user.

The FSK modulation unit B6 can enable the operation unit B4 to transform the longitude and latitude data of the user and the communication data of an opposite user to voice-frequency signals for analog data transmission of the radio communication interface unit B7.

The radio communication interface unit B7 is used to establish radio connection with a radio communication device. The radio communication device can be a GSM system, a DCS system, a radio intercom, or any device for radio communication.

The voice transmission unit B8 can transform and forward voice signals of the voice procession unit B9 to the opposite user through the radio communication interface unit B7, or can transform incoming voice signals provided by the radio communication interface unit B7 into signals acceptable to the voice procession unit B9.

The voice procession unit B9 is used to process the voice signals from the microphone M′ and the voice transmission unit B8. The voice procession unit B9 is also able to eliminate noises, echoes and any unexpected voices.

The human-machine interface B0 is used for the user to input settings of the apparatus. The human-machine interface B0 can be a key-type or touch screen-type input device.

The mix unit C is used to mix or separate the voice-frequency signals provided by the FSK modulation unit B9 for being further transmitted through the radio transmission interface unit B7.

The microphone M′ can be used for the user to input voices.

The speaker S′ can be used for outputting the voice signals of the voice procession unit A9.

By providing all the units described above, the user is able to locate quickly and easily the position of the opposite user.

While the present invention has been particularly shown and described with reference to a preferred embodiment, it will be understood by those skilled in the art that various changes in form and detail may be without departing from the spirit and scope of the present invention.

I claim:

1. An apparatus for locating a receiver of radio communication, comprising:
a system control unit for controlling the apparatus;
a direction detection unit, using a heading direction of a vehicle or the apparatus as a standard direction for judging a direction of the receiver;
a longitude-and-latitude detection unit, receiving a satellite's signals by applying a GPS to obtain longitude and latitude data of a user;
an operation unit, controlled by the system control unit for receiving signals from the direction detection unit, the longitude-and-latitude detection unit and a following data transmission unit;
a display unit for displaying display data from the operation unit;
the data transmission unit for enabling the operation unit to transform the longitude and latitude data of the user and communication data of an opposite user and for forwarding data to a radio communication interface unit of the opposite user through a radio communication interface unit of the user;
the radio communication interface unit for establishing radio connection with a radio communication device;
a voice transmission unit for transforming voice signals of a voice procession unit and forwarding the transformed voice signals to the opposite user through the radio communication interface unit and for transforming incoming voice signals provided by the radio communication interface unit into signals acceptable to the voice procession unit;
the voice procession unit for processing the voice signals from a microphone or the voice transmission unit;
a human-machine interface for the user to input settings of the apparatus;
the microphone for the user to input voice; and
a speaker for outputting the voice signals of the voice procession unit;
wherein, by providing all the units above, the user is able to locate quickly and easily a position of the opposite user.

2. The apparatus for locating a receiver of radio communication according to claim 1, wherein said data transmission unit includes an FSK modulation unit and a mix unit for transforming digital data into voice-frequency signals to facilitate transmission of said radio transmission interface unit.

3. The apparatus for locating a receiver of radio communication according to claim 1, wherein said direction detection unit is selected from a gyroscope, an electronic compass, and a direction detection element that utilizes GPS Doppler effect.

4. The apparatus for locating a receiver of radio communication according to claim 1, wherein said radio communication device is selected from a GSM system, a DCS system, a radio intercom and a device for radio communication.

5. The apparatus for locating a receiver of radio communication according to claim 1, wherein said voice procession unit is able to eliminate noises, echoes and unexpected voices.

6. The apparatus for locating a receiver of radio communication according to claim 1, wherein said human-machine interface is a key-type or touch screen-type input device.
